(19) United States
(12) Patent Application Publication
(10) Pub. No.: US 2017/0358274 A1
(43) Pub. Date: Dec. 14, 2017

(54) IMAGE CORRECTION TO COMPENSATE FOR VISUAL IMPAIRMENTS

(71) Applicant: Microsoft Technology Licensing, LLC, Redmond, WA (US)

(72) Inventor: Hugo Garcia, New York, NY (US)

(73) Assignee: Microsoft Technology Licensing, LLC, Redmond, WA (US)

(21) Appl. No.: 15/182,116

(22) Filed: Jun. 14, 2016

(51) Int. Cl. G09G 5/02; G06F 3/0481; G09G 5/10; G06F 3/0484

(52) U.S. Cl. CPC G09G 5/02; G06F 3/04845; G06F 3/0481; G06F 3/04842; G09G 5/10; G09G 2340/06; G09G 2320/0626; G09G 2340/14

(57) ABSTRACT

Aspects of the present disclosure relate to systems and methods for providing image correction to compensate for visual impairments. In one aspect, a special accessibility mode associated with an application comprising content is identified. One or more colors of the content may be inverted to decrease a luminance of the content. The one or more colors of the content may be shifted along a color wheel. A linear function may be applied to the one or more colors of the content to control a color intensity of the one or more colors of the content. The content may be displayed within the application in a user interface (e.g., of a client computing device).

### BACKGROUND

People with vision disabilities often are sensitive to light and can generally perceive a small set of shapes and/or colors but not the entire range of shapes and/or colors in content. Current techniques for providing image correction for people with vision disabilities include providing a high contrast mode and/or an inverse mode for viewing content. By effectively darkening the screen and/or inverting the colors of content, the content is easier to read for people with vision disabilities. However, with these techniques color fidelity is lost in the content. For example, red hues turn green and yellow hues turn blue/purple. In this regard, current techniques for providing image correction for people with vision disabilities make it difficult for people with vision disabilities to clearly and accurately consume content and/or follow along in content with their peers. In turn, current techniques for providing image correction for people with vision disabilities are inefficient and inadequate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for providing image correction to compensate for visual impairments. In one aspect, a special accessibility mode associated with an application comprising content is identified. One or more colors of the content may be inverted to decrease a luminance of the content. The one or more colors of the content may be shifted along a color wheel. A linear function may be applied to the one or more colors of the content to control a color intensity of the one or more colors of the content. The content may be displayed within the application in a user interface (e.g., of a client computing device).

In another aspect, content having at least a first color and a second color having a first color intensity may be displayed within an application in a user interface. In one example, the first color is white. In response to receiving a selection of a special accessibility mode associated with the application: the white color may be inverted to a black color, the second color having a first color intensity may be inverted to a third color, the black color of the content and the third color of the content may be shifted along a color wheel, a linear function may be applied to the black color of the content and the third color of the content, and in response to applying the linear function to the black color of the content and the third color of the content, the content may be displayed within the application in a user interface. The white color of the content may be displayed as the black color and the second color having the first color intensity of the content may be displayed as the second color having a second color intensity.

### DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an example view of a word processing application, according to an example aspect.

FIG. 2A illustrates one view in a progression of views of a word processing application, according to an example aspect.

FIG. 2B illustrates another view in the progression of views of the word processing application of FIG. 2A, according to an example aspect.

FIG. 2C illustrates another view in the progression of views of the word processing application of FIG. 2A, according to an example aspect.

FIG. 2D illustrates another view in the progression of views of the word processing application of FIG. 2A, according to an example aspect.

FIG. 3 illustrates an exemplary method for providing image correction to compensate for visual impairments, according to an example aspect.

FIG. 4 illustrates a computing system suitable for implementing the enhanced image correction technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to providing image correction to compensate for visual impairments. For example, application software may provide a special accessibility mode for users who have visual disabilities. In this regard, a user having visual disabilities may select a special accessibility mode when using an application such as word processing applications, spreadsheet applications, and electronic slide presentation applications, to name a few. In aspects, an application may include user interface elements such as thumbnails, which may represent a scaled down version of software application and/or images such as documents, spreadsheets, presentation slides, and other objects. In one aspect, when a special accessibility mode associated with an application comprising content (e.g., thumbnails including images) is identified, a three step color transformation may be applied to the content to compensate for visual impairments. In turn, luminance of the content may be decreased, color fidelity of the content may be maintained, and a color intensity of the content may be customized

As discussed above, current techniques for providing image correction for people with vision disabilities include providing a high contrast mode and/or an inverse mode for viewing content. By effectively darkening the screen and/or inverting the colors of content, the content is easier to read for people with vision disabilities. However, with these techniques color fidelity is lost in the content. For example, red hues turn green and yellow hues turn purple. In this regard, current techniques for providing image correction for people with vision disabilities make it difficult for people with vision disabilities to clearly and accurately consume content and/or follow along in content with their peers. In turn, current techniques for providing image correction for people with vision disabilities are inefficient and inadequate.

Accordingly, aspects described herein include providing image correction to compensate for visual impairments by applying a three step color transformation to content of software applications. In this regard, a special accessibility mode associated with an application comprising content may be identified. In one example, the first step of the color transformation may include inverting one or more colors of the content to decrease a luminance of the content. For example, when the one or more colors of the content includes white, the white color may be inverted to black color. In another example, the second step of the color transformation may include shifting the one or more colors of the content along a color wheel. For example, the one or more colors (e.g., hues) may be shifted 180 degrees along the color wheel. In one case, after the first step of the color transformation and before the second step of the color transformation, the one or more inverted colors of the content may be converted from a first color space to a second color space. In another example, the third step of the color transformation may include applying a linear function to the one or more colors of the content. Applying a linear function to the one or more colors of the content may facilitate customizing and/or controlling a color intensity of the one or more colors of the content. In one case, after the second step of the color transformation and before the third step of the color transformation, the one or more colors of the content may be converted from the second color space back to the first color space. In another case, after the third step of the color transformation, the one or more colors of the content may be converted from the second color space back to the first color space. In response to applying the three step color transformation to content of an application, the content may be displayed within the application in a user interface (e.g., of a client computing device) such that a person with visual disabilities can view the content clearly and accurately. In turn, a technical effect that may be appreciated is that displaying the content of an application in a clear, understandable, and accurate manner facilitates a compelling visual and functional experience to allow a user with visual disabilities/impairments to efficiently interact with the user interface, consume content in applications, and follow along with peers during collaboration.

Further aspects described herein include displaying content having at least a first color and a second color having a first color intensity within an application in a user interface. In one example, the first color is white. In response to receiving a selection of a special accessibility mode associated with the application, a three step color transformation may be applied to the content of the application. For example, the white color may be inverted to a black color and the second color having a first color intensity may be inverted to a third color. In one example, the second color may include any color within the color spectrum. In another example, the third color may include any color within the color spectrum. In one case, the third color is a different color than the second color. In further examples, the black color of the content and the third color of the content may be shifted along a color wheel. For example, the black color and the third color may be shifted 180 degrees along the color wheel. In another example, a linear function may be applied to the black color of the content and the third color of the content (e.g., after the colors have been shifted along the color wheel). In response to applying the linear function to the black color of the content and the third color of the content, the content may be displayed within the application in a user interface. In this example, after the three step color transformation has been applied to the content of the application, the white color of the content may be displayed as the black color and the second color having the first color intensity may be displayed as the second color having a second color intensity. For example, when the second color having a first color intensity is red, the second color may be displayed as a light red and/or pink for example (e.g., red having a second color intensity). The second color having a first color intensity as red and the second color having a second color intensity as light red and/or pink is exemplary only. It is appreciated that the second color may include any color in the color spectrum and the first and second color intensities of the second color may include any color intensities of the second color.

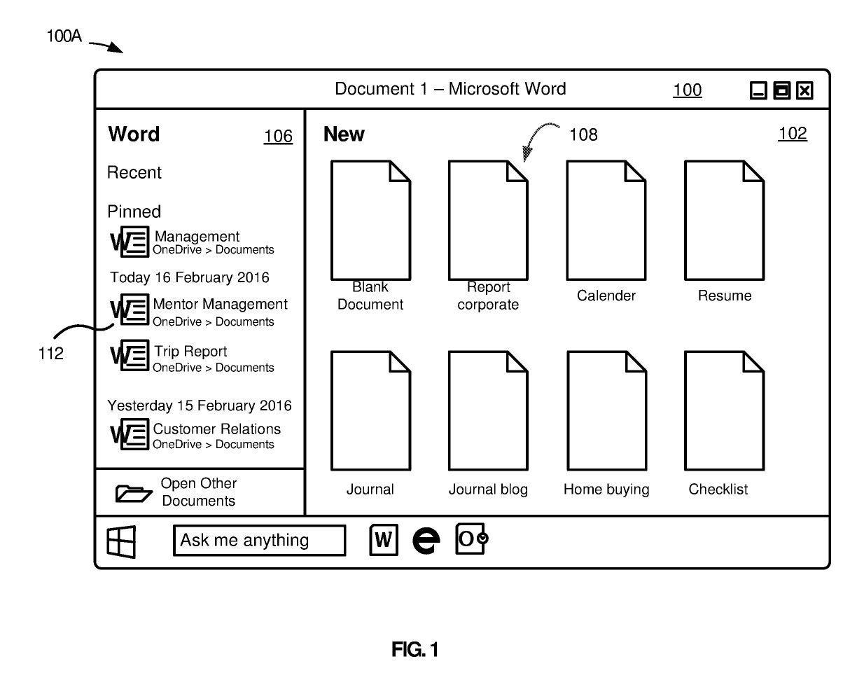

Referring now to the drawings, in which like numerals represent like elements through the several figures, aspects of the present disclosure and the exemplary operating environment will be described. With reference to FIG. 1, one view 100A of a word processing application 100 is illustrated. While the word processing application 100 is illustrated in FIG. 1, it is appreciated that any application including content such as documents, images, templates, and the like, such as word processing applications, spreadsheet applications, electronic slide presentation applications, email applications, chat applications, voice applications, and the like may be utilized with the present disclosure.

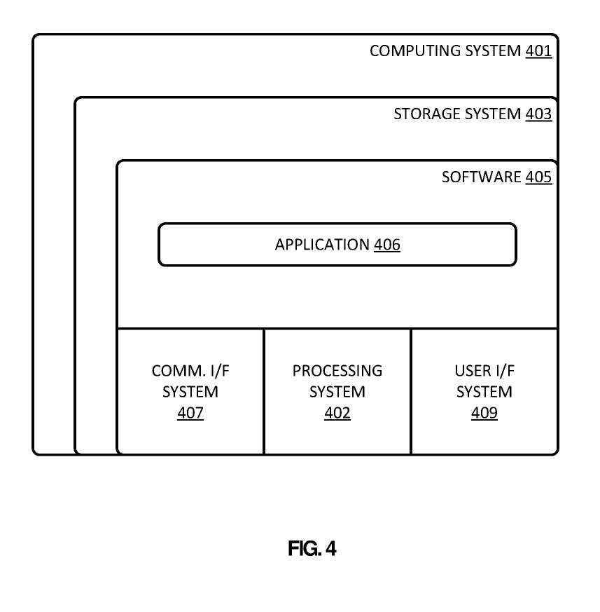

In aspects, the word processing application 100 may be implemented on a client computing device (e.g., such as the computing device illustrated in FIG. 4). In a basic configuration, the client computing device is a handheld computer having both input elements and output elements. The client computing device may be any suitable computing device for implementing the word processing application 100 for providing image correction to compensate for visual impairments. For example, the client computing device may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing device for implementing the word processing application 100 for providing image correction to compensate for visual impairments may be utilized.

In aspects, the word processing application 100 may be implemented on a server computing device (e.g., such as the computing device illustrated in FIG. 4). The server computing device may provide data to and from a client computing device through a network. In aspects, the word processing application 100 may be implemented on more than one server computing device, such as a plurality of server computing devices. As discussed above, the server computing device may provide data to and from a client computing device through a network. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums. In this regard, content of an application may be displayed on a user interface of a client computing device.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

In aspects, the view 100A of the word processing application 100 is one example of a view a user may encounter when interacting with the word processing application 100. The view 100A of the word processing application 100 may include a canvas 102, a contextual panel 106, and one or more user interface elements 108. The various components may be implemented using hardware, software, or a combination of hardware and software. The canvas 102 may display user interface elements 108. The contextual panel 106 may include recent files 112 associated with the word processing application 100. The user interface elements 108 may include a plurality of various types of thumbnails such as documents, templates, images, and/or any other elements. For example, the different types of documents, templates, and/or images may include a blank document, a corporate report template, a calendar, a resume, a checklist, a journal document, and a home buying document, to name a few.

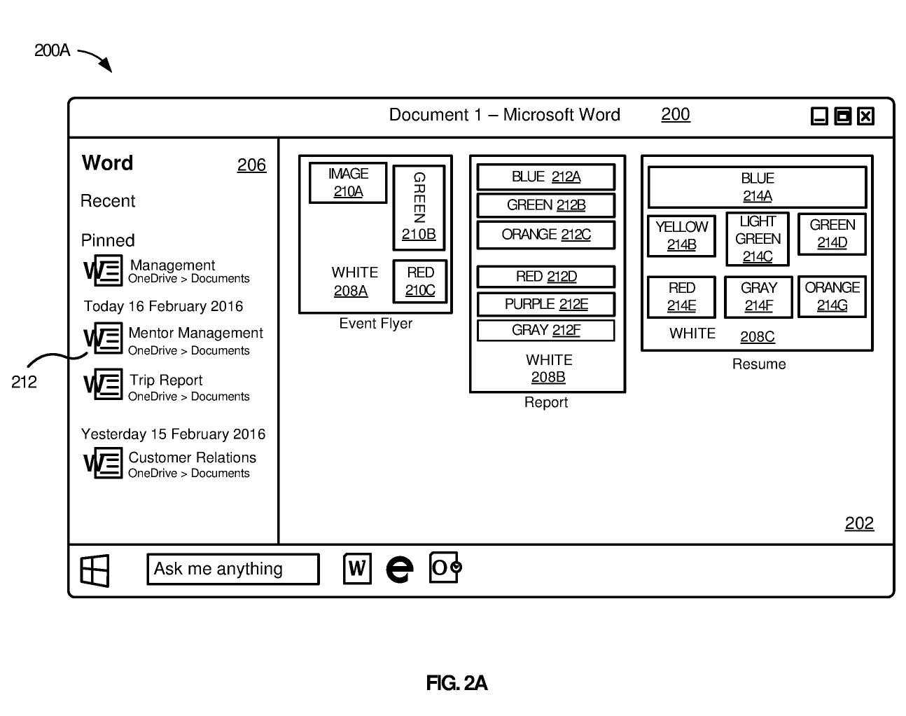

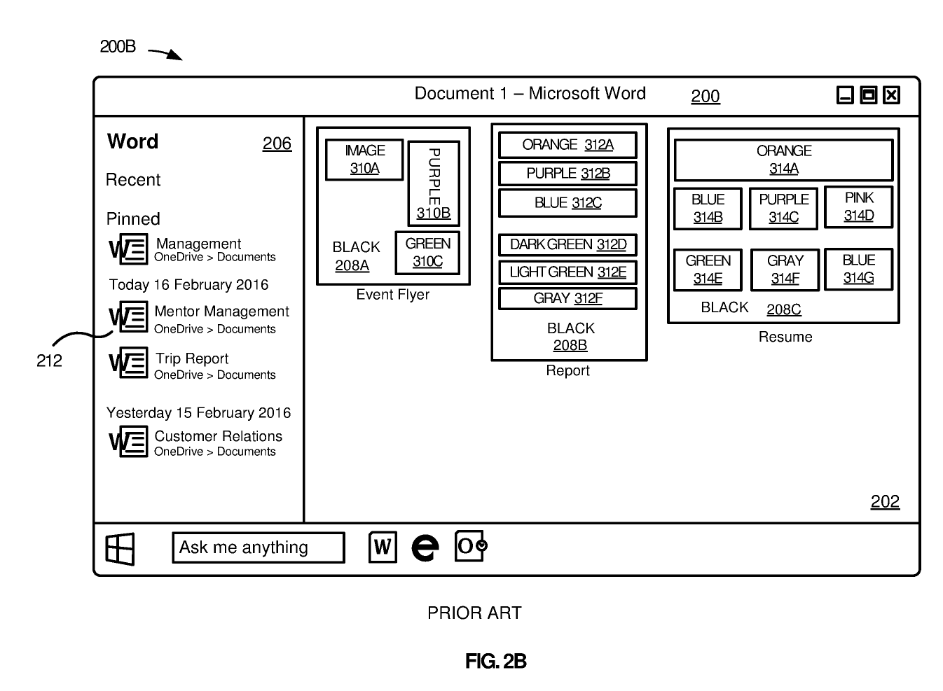

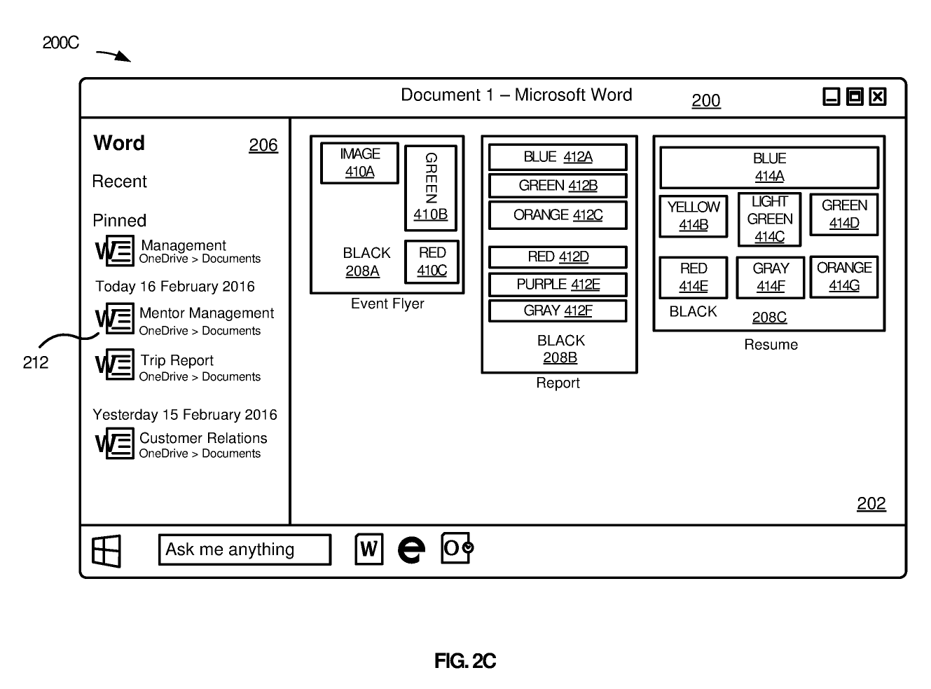

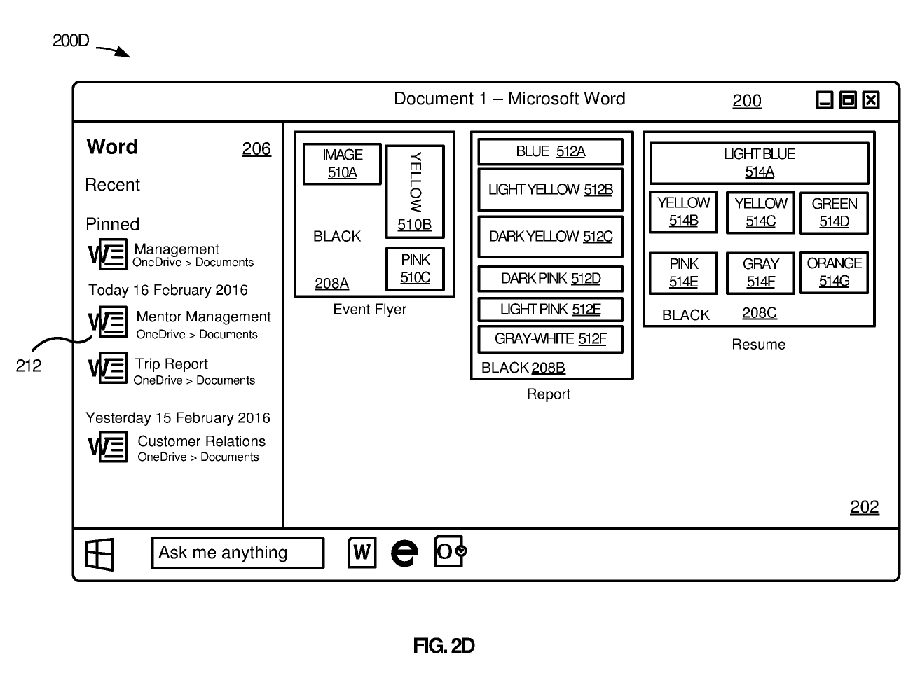

As discussed above, application software may provide a special accessibility mode for users who have visual disabilities. In this regard, the word processing application 100 may include a special accessibility mode. In one aspect, when the special accessibility mode associated with the word processing application 100 is selected by a user having a visual disability/impairment, a three step color transformation may be applied to the content of the user interface elements 108 to compensate for visual impairments, which will be discussed in detail below herein relative to FIGS. 2C-2D. In turn, luminance of the content may be decreased, color fidelity of the content may be maintained, and a color intensity of the content may be customized In one example, the content is external third party content. For example, external third party content may include content from a website and/or community-authored content. In one case, the external third party content is content that is generated and/or controlled by a third party entity rather than generated by the word processing application 100 itself. In another example, the content is first party content. For example, the first party content is content that is generated by the word processing application 100 itself. In one case, the content includes the user interface elements 108 (e.g., the content of the word processing application 100 includes user interface elements 108 and/or is included within user interface elements 108).

In another example, the word processing application 100 may be implemented as a user interface component. In one case, the user interface component may be a touchable user interface that is capable of receiving input via contact with a screen of the client computing device, thereby functioning as both an input device and an output device. For example, content may be displayed, or output, on the screen of the client computing device and input may be received by contacting the screen using a stylus or by direct physical contact of a user, e.g., touching the screen. Contact may include, for instance, tapping the screen, using gestures such as swiping or pinching the screen, sketching on the screen, etc.

In another case, the user interface component may be a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing device, thereby functioning as both an input device and an output device. For example, content may be displayed, or output, on the screen of the client computing device and input may be received by contacting the screen using a cursor, for example. In this regard, contact may include, for example, placing a cursor on the non-touchable user interface using a device such as a mouse.

Referring now to FIG. 2A, one view 200A in a progression of views of a word processing application 200 is illustrated. As discussed above, while the word processing application 200 is illustrated in FIG. 2A, it is appreciated that any application including content such as documents, images, templates, and the like, such as word processing applications, spreadsheet applications, electronic slide presentation applications, email applications, chat applications, voice applications, and the like may be utilized with the present disclosure. The view 200A of the word processing application 200 is another example of a view a user may encounter when interacting with the word processing application 200.

In one example, similar to the view 100A of the word processing application 100, the view 200A may include a canvas 202, a contextual panel 206, and user interface elements 208A-208C. The various components may be implemented using hardware, software, or a combination of hardware and software. The canvas 202 may display user interface elements 208A-208C. The contextual panel 206 may include recent files 212 associated with the word processing application 200. The view 200A of the word processing application 200 includes content when the word processing application 200 is not in a special accessibility mode. That is, the user interface elements 208A-208C include original content displayed before a special accessibility mode associated with the word processing application 200 is identified (e.g., when the word processing application 200 is in a default/standard mode). In the example illustrated in FIG. 2A, the user interface element 208A is an event flyer. The event flyer is the color white and includes a first portion 210A, a second portion 210B, and a third portion 210C of content. In one example, the content may include any content, data and/or information such as images, text, art, photos, icons, and the like. The first portion of content 210A includes an image. In one example, the image includes two people having brown hair where the first person is wearing a blue shirt, and the second person is wearing a pink shirt (not illustrated). The second portion of content 210B is the color green. The third portion of content 210C is the color red.

In the example illustrated in FIG. 2A, the user interface element 208B is a report. The report is the color white and includes a plurality of portions 212A-212F of content. As discussed herein, the content may include may include any content, data and/or information such as images, text, art, photos, icons, and the like. The first portion of content 212A is the color blue, the second portion of content 212B is the color green, the third portion of content 212C is the color orange, the fourth portion of content 212D is the color red, the fifth portion of content 212E is the color purple, and the sixth portion of content 212F is the color gray.

In the example illustrated in FIG. 2A, the user interface element 208C is a resume. The resume is the color white and includes a plurality of portions 214A-214G of content. As discussed herein, the content may include any content, data and/or information such as images, text, art, photos, icons, and the like. The first portion of content 214A is the color blue, the second portion of content 214B is the color yellow, the third portion of content 214C is the color light green, the fourth portion of content 214D is the color green, the fifth portion of content 214E is the color red, the sixth portion of content 214F is the color gray, and the seventh portion of content 214G is the color orange.

As discussed above, application software may provide a special accessibility mode for users who have visual disabilities. In this regard, the word processing application 200 may include a special accessibility mode. In one aspect, when the special accessibility mode associated with the word processing application 200 is selected by a user having a visual disability/impairment, a three step color transformation may be applied to the content of the user interface elements 208A-208C to compensate for visual impairments, which will be described in detail below herein relative to FIGS. 2C-2D.

Referring now to FIG. 2B, another view 200B in a progression of views of the word processing application 200 is illustrated. The view 200B of the word processing application 200 is another example of a view a user may encounter when interacting with the word processing application 200. In particular, the view 200B of the word processing application 200 illustrates at least one prior technique (e.g., an inverse mode) for providing image correction for people with vision disabilities for viewing content. In one example, similar to the view 200A illustrated in FIG. 2A, the view 200B may include the canvas 202, the contextual panel 206, recent files 212, and the user interface elements 208A-208C. The view 200B of the word processing application 200 includes the content (e.g., user interface elements 208A-208C) illustrated relative to FIG. 2A after a prior technique such as an inverse mode has been applied to the content. That is, the user interface elements 208A-208C represent the same content illustrated relative to FIG. 2A when an inverse mode has been applied to the word processing application 200. For example, in response to receiving a selection of an inverse mode associated with the word processing application 200 by a user with visual disabilities, the view 200B of the word processing application 200 may be rendered and/or displayed within the application 200 in the user interface of a client computing device. In this regard, the content of the user interface elements 208A-208C illustrated in FIG. 2B represents content when the word processing application 200 is in an inverse mode (e.g., a prior technique used for image correction for people with visual disabilities).

In the example illustrated in FIG. 2B, the user interface element 208A is the same event flyer illustrated in FIG. 2A. After the inverse mode technique has been applied to the content of the word processing application 200, the event flyer is the color black and includes a first portion 310A, a second portion 310B, and a third portion 310C of content. In one example, the content may include any content, data and/or information such as images, text, art, photos, icons, and the like. The first portion of content 310A represents the first portion of content (e.g., the image) 210A illustrated in FIG. 2A after the inverse mode technique has been applied to the first portion of content 210A. In this regard, the image includes a white blob with orange and green colors (not illustrated). The second portion of content 310B represents the second portion of content 210B illustrated in FIG. 2A after the inverse mode technique has been applied to the second portion of content 210B. In this regard, second portion of content 310B is the color purple. The third portion of content 310C represents the second portion of content 210C illustrated in FIG. 2A after the inverse mode technique has been applied to the third portion of content 210C. In this regard, third portion of content 310C is the color green.

In the example illustrated in FIG. 2B, the user interface element 208B is the same report illustrated in FIG. 2A. After the inverse mode technique has been applied to the content of the word processing application 200, the report is the color black and includes a plurality of portions 312A-312F of content. As discussed herein, the content may include any content, data and/or information such as images, text, art, photos, icons, and the like. The plurality of portions 312A-312F represent the plurality of portions 212A-212F illustrated in FIG. 2A after the inverse mode technique has been applied to the plurality of portions 212A-212F of content. In this regard, first portion of content 312A is the color orange, the second portion of content 312B is the color purple, the third portion of content 312C is the color blue, the fourth portion of content 312D is the color dark green, the fifth portion of content 312E is the color light green, and the sixth portion of content 312F is the color gray.

In the example illustrated in FIG. 2B, the user interface element 208C is the same resume illustrated in FIG. 2A. After the inverse mode technique has been applied to the content of the word processing application 200, the report is the color black and includes a plurality of portions 314A-314G of content. As discussed herein, the content may include any content, data and/or information such as images, text, art, photos, icons, and the like. The plurality of portions 314A-314G represent the plurality of portions 214A-214G illustrated in FIG. 2A after the inverse mode technique has been applied to the plurality of portions 214A-214G of content. In this regard, first portion of content 314A is the color orange, the second portion of content 314B is the color blue, the third portion of content 314C is the color purple, the fourth portion of content 314D is the color pink, the fifth portion of content 314E is the color green, the sixth portion of content 314F is the color gray, and the seventh portion of content 314G is the color blue.

As illustrated in FIG. 2B, when the inverse mode technique is used to compensate for visual disabilities, the screen may be darkened and/or the colors of content made be inverted. However, with these techniques color fidelity is lost in the content. For example, as illustrated in FIG. 2B, red hues turn green, yellow hues turn blue/purple, blue hues turn orange, and the like. Furthermore, content within images including, for example, pictures of people may appear as a white blob to a user with visual disabilities.

Referring now to FIG. 2C, another view 200C in a progression of views of the word processing application 200 is illustrated. The view 200C of the word processing application 200 is another example of a view a user may encounter when interacting with the word processing application 200. In particular, the view 200C of the word processing application 200 illustrates one example of content of the word processing application 200 when a special accessibility mode is applied to the word processing application 200 in accordance with the present disclosure. In one example, similar to the view 200A illustrated in FIG. 2A, the view 200C may include the canvas 202, the contextual panel 206, recent files 212, and the user interface elements 208A-208C. The view 200C of the word processing application 200 includes the content (e.g., user interface elements 208A-208C) illustrated relative to FIG. 2A after a special accessibility mode has been applied to the content. That is, the user interface elements 208A-208C represent the same content illustrated relative to FIG. 2A when a special accessibility mode has been applied to the word processing application 200. For example, in response to receiving a selection of a special accessibility mode associated with the word processing application 200 by a user with visual disabilities, the view 200C of the word processing application 200 may be rendered and/or displayed within the application 200 in the user interface of a client computing device. In this regard, the content of the user interface elements 208A-208C illustrated in FIG. 2C represents content when the word processing application 200 is in a special accessibility mode (e.g., when a three step color transformation according to the present disclosure is applied to the content of the user interface elements 208A-208C to compensate for visual impairments).

In the example illustrated in FIG. 2C, the user interface element 208A is the same event flyer illustrated in FIG. 2A. In one example, after the three step color transformation is applied to the content of the word processing application 200, the event flyer is the color black and includes a first portion 410A, a second portion 410B, and a third portion 410C of content. For example, a special accessibility mode associated with the word processing application 200 may be identified. As discussed herein, the special accessibility mode is a mode for providing clear and accurate content for users of the application with visual impairments/disabilities. In one case, during a first step of the color transformation, one or more colors of the content (e.g., the first portion 210A, the second portion 210B, and the third portion 210C) may be inverted. In one example, when the one or more colors of the content are inverted, a luminance of the content is decreased. In one case, during a second step of the color transformation, the one or more inverted colors of the content may be shifted along a color wheel. In one example, the one or more colors of the content are shifted 180 degrees along the color wheel. In one case, during a third step of the color transformation, a linear function may be applied to the one or more colors of the content. In one example, when the linear function is applied to the one or more colors of the content, a color intensity of the one or more colors of the content may be controlled and/or customized

In response to applying the three step color transformation to the content of the word processing application 200, the content (e.g., the user interface elements 208A-208C) may be displayed within the word processing application 200 in the user interface of a client computing device, as illustrated in FIG. 2C. The first portion of content 410A represents the first portion of content (e.g., the image) 210A illustrated in FIG. 2A after the three step color transformation has been applied to the first portion of content 210A. In this regard, the image includes two people having brown hair where the first person is wearing a blue shirt, and the second person is wearing a pink shirt (not illustrated). The second portion of content 410B represents the second portion of content 210B illustrated in FIG. 2A after the three step color transformation has been applied to the second portion of content 210B. In this regard, second portion of content 410B is the color green. The third portion of content 410C represents the second portion of content 210C illustrated in FIG. 2A after the three step color transformation has been applied to the third portion of content 210C. In this regard, third portion of content 410C is the color red.

In the example illustrated in FIG. 2C, the user interface element 208B is the same report illustrated in FIG. 2A. After the three step color transformation has been applied to the content of the word processing application 200, the report is the color black and includes a plurality of portions 412A-412F of content. As discussed herein, the content may include any content, data and/or information such as images, text, art, photos, icons, and the like. The plurality of portions 412A-412F represent the plurality of portions 212A-212F illustrated in FIG. 2A after the three step color transformation has been applied to the plurality of portions 212A-212F of content. In this regard, first portion of content 412A is the color blue, the second portion of content 412B is the color green, the third portion of content 412C is the color orange, the fourth portion of content 412D is the color red, the fifth portion of content 412E is the color purple, and the sixth portion of content 412F is the color gray.

In the example illustrated in FIG. 2C, the user interface element 208C is the same resume illustrated in FIG. 2A. After the three step color transformation has been applied to the content of the word processing application 200, the report is the color black and includes a plurality of portions 414A-414G of content. As discussed herein, the content may include any content, data and/or information such as images, text, art, photos, icons, and the like. The plurality of portions 414A-414G represent the plurality of portions 214A-214G illustrated in FIG. 2A after the three step color transformation has been applied to the plurality of portions 214A-214G of content. In this regard, the first portion of content 414A is the color blue, the second portion of content 414B is the color yellow, the third portion of content 414C is the color light green, the fourth portion of content 414D is the color green, the fifth portion of content 414E is the color red, the sixth portion of content 414F is the color gray, and the seventh portion of content 414G is the color orange.

As illustrated in FIG. 2C, when the three step color transformation is applied to content of the word processing application 200 to compensate for visual impairments, luminance of the content may be decreased and color fidelity of the content may be maintained. For example, as illustrated in FIG. 2C, red hues remain red, yellow hues remain yellow, green hues remain green, and the like.

Referring now to FIG. 2D, another view 200D in a progression of views of the word processing application 200 is illustrated. The view 200D of the word processing application 200 is another example of a view a user may encounter when interacting with the word processing application 200. In particular, the view 200D of the word processing application 200 illustrates one example of content of the word processing application 200 when a special accessibility mode is applied to the word processing application 200 in accordance with the present disclosure. In one example, similar to the view 200A illustrated in FIG. 2A, the view 200D may include the canvas 202, the contextual panel 206, recent files 212, and the user interface elements 208A-208C. The view 200D of the word processing application 200 includes the content (e.g., user interface elements 208A-208C) illustrated relative to FIG. 2A after a special accessibility mode has been applied to the content. That is, the user interface elements 208A-208C represent the same content illustrated relative to FIG. 2A when a special accessibility mode has been applied to the word processing application 200. For example, in response to receiving a selection of a special accessibility mode associated with the word processing application 200 by a user with visual disabilities, the view 200D of the word processing application 200 may be rendered and/or displayed within the application 200 in the user interface of a client computing device. In this regard, the content of the user interface elements 208A-208C illustrated in FIG. 2D represents content when the word processing application 200 is in a special accessibility mode (e.g., when a three step color transformation according to the present disclosure is applied to the content of the user interface elements 208A-208C to compensate for visual impairments).

In the example illustrated in FIG. 2D, the user interface element 208A is the same event flyer illustrated in FIG. 2A. In one example, after the three step color transformation is applied to the content of the word processing application 200 as discussed herein, the event flyer is the color black and includes a first portion 510A, a second portion MOB, and a third portion 510C of content. In one aspect, in response to applying the three step color transformation to the content of the word processing application 200, the content (e.g., the user interface elements 208A-208C) may be displayed within the word processing application 200 in the user interface of a client computing device, as illustrated in FIG. 2D.

In one aspect, the first portion of content 510A represents the first portion of content (e.g., the image) 210A illustrated in FIG. 2A after the three step color transformation has been applied to the first portion of content 210A. In this regard, the image includes two people having brown hair where the first person is wearing a blue shirt, and the second person is wearing a pink shirt (not illustrated). The second portion of content 510B represents the second portion of content 210B illustrated in FIG. 2A after the three step color transformation has been applied to the second portion of content 210B. In this regard, second portion of content 510B is the color yellow. The third portion of content 510C represents the second portion of content 210C illustrated in FIG. 2A after the three step color transformation has been applied to the third portion of content 210C. In this regard, third portion of content 510C is the color pink. In this example, the second portion of content 210B illustrated in FIG. 2A is the color green before the three step color transformation is applied to the second portion of content 210B. After the three step color transformation is applied to the second portion of content 210B, the second portion of content 510B is the color yellow. Additionally, in this example, the third portion of content 210C illustrated in FIG. 2A is the color red before the three step color transformation is applied to the third portion of content 210C. After the three step color transformation is applied to the third portion of content 210C, the second portion of content 510C is the color pink. In this regard, by applying a linear function to the second portion of content 210B and the third portion of content 210C, the color intensity of the second portion of content 510B and the third portion of content 510C may be reduced. In turn, users of the word processing application 200 with severe vision disabilities who cannot see red color and green color but who can see yellow color and pink color (e.g., lighter colors, less intense colors) may still consume the content of the word processing application 200 clearly and accurately by trading some visual fidelity for intensity correction while also maintaining the color fidelity.

In the example illustrated in FIG. 2D, the user interface element 208B is the same report illustrated in FIG. 2A. After the three step color transformation has been applied to the content of the word processing application 200, the report is the color black and includes a plurality of portions 512A-512F of content. As discussed herein, the content may include any content, data and/or information such as images, text, art, photos, icons, and the like. The plurality of portions 512A-512F represent the plurality of portions 212A-212F illustrated in FIG. 2A after the three step color transformation has been applied to the plurality of portions 212A-212F of content. In this regard, first portion of content 512A is the color blue, the second portion of content 512B is the color light yellow, the third portion of content 512C is the color dark yellow, the fourth portion of content 512D is the color dark pink, the fifth portion of content 512E is the color light pink, and the sixth portion of content 512F is the color gray-white.

In the example illustrated in FIG. 2D, the user interface element 208C is the same resume illustrated in FIG. 2A. After the three step color transformation has been applied to the content of the word processing application 200, the report is the color black and includes a plurality of portions 514A-514G of content. As discussed herein, the content may include any content, data and/or information such as images, text, art, photos, icons, and the like. The plurality of portions 514A-514G represent the plurality of portions 214A-214G illustrated in FIG. 2A after the three step color transformation has been applied to the plurality of portions 214A-214G of content. In this regard, the first portion of content 514A is the color light blue, the second portion of content 514B is the color yellow, the third portion of content 514C is the color yellow, the fourth portion of content 514D is the color green, the fifth portion of content 514E is the color pink, the sixth portion of content 514F is the color gray, and the seventh portion of content 514G is the color orange.

As illustrated in FIG. 2D, when the three step color transformation is applied to content of the word processing application 200 to compensate for visual impairments, luminance of the content may be decreased, color fidelity of the content may be maintained, and a color intensity of the content may be controlled, adjusted, and/or customized. For example, as illustrated in FIG. 2D, by applying the linear function to one or more colors of the portions of content of the user interface elements 208A-208C, the one or more colors may remain the same and/or the intensity of the one or more colors may be adjusted. For example, in the example illustrated in FIG. 2D, the color intensity of the second portion of content 210B is more intense than the color intensity of the second portion of content 510B, the color intensity of the third portion of content 210C is more intense than the color intensity of the third portion of content 510C, the color intensity of the second portion of content 212B is more intense than the color intensity of the second portion of content 512B, the color intensity of the third portion of content 212C is more intense than the color intensity of the third portion of content 512, the color intensity of the fourth portion of content 212D is more intense than the color intensity of the fourth portion of content 512D, the color intensity of the fifth portion of content 212E is more intense than the color intensity of the fifth portion of content 512E, the color intensity of the first portion of content 214A is more intense than the color intensity of the first portion of content 514A, the color intensity of the third portion of content 214C is more intense than the color intensity of the third portion of content 514C, and the color intensity of the fifth portion of content 214E is more intense than the color intensity of the fifth portion of content 514E. In turn, some visual fidelity may be traded for intensity correction while also maintaining the color fidelity such that users with visual disabilities can view and consume content clearly and accurately.

It is appreciated that while FIGS. 2A-2D illustrate specific examples for providing image correction to compensate for visual disabilities, the discussion of the word processing application 200, the user interface elements 208A-208C, the portions of content (and the various colors of the portions of content) 210A-210C, 310A-310C, 410A-410C, 510A-510C, 212A-212F, 312A-312F, 412A-412F, 512A-512F, 214A-214G, 314A-314G, 414A-414G, 514A-514G is exemplary only and should not be considered as limiting. Any suitable number and/or type of applications, user interface elements, content and/or portions of content, and colors may be utilized in conjunction with the present disclosure.

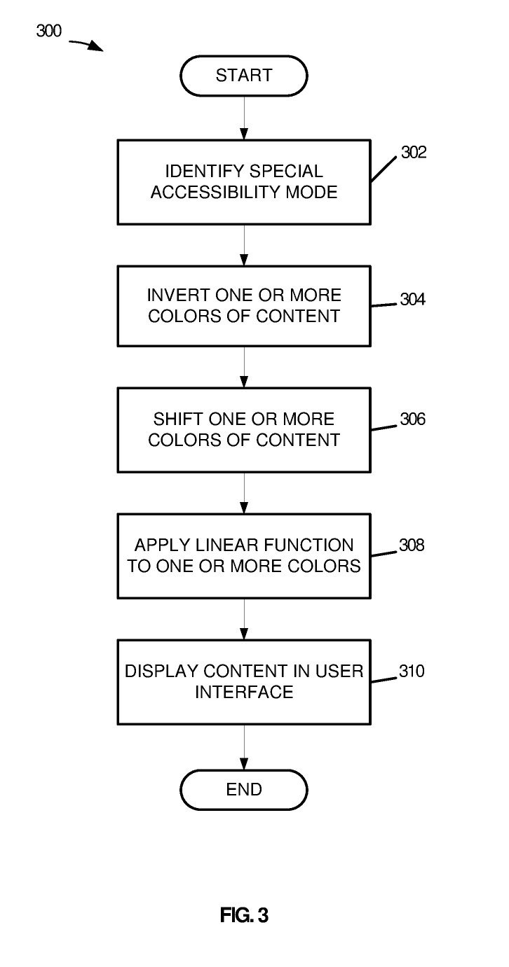

Referring now to FIG. 3, an exemplary method 300 for providing image correction to compensate for visual impairments, according to an example aspect is shown. Method 300 may be implemented on a computing device or a similar electronic device capable of executing instructions through at least one processor. The corrected content may be displayed by any suitable software application. For example, the software application may be one of an email application, a social networking application, project management application, a collaboration application, an enterprise management application, a messaging application, a word processing application, a spreadsheet application, a database application, a presentation application, a contacts application, a calendaring application, etc. This list is exemplary only and should not be considered as limiting. Any suitable application for displaying the corrected content may be utilized by method 300.

Method 300 may begin at operation 302, where a special accessibility mode associated with an application comprising content is identified. In one example, the special accessibility mode is a mode for providing clear and accurate content for users of the application having visual impairments/disabilities. In this regard, the application may include a special accessibility mode. In one aspect, when the special accessibility mode associated with the application is selected by a user having a visual disability/impairment, a three step color transformation may be applied to the content of the application to compensate for visual impairments.

When a special accessibility mode associated with an application comprising content is identified, flow proceeds to operation 304 where one or more colors of the content may be inverted. In one example, when the one or more colors of the content are inverted, a luminance of the content is decreased. The one or more colors may be inverted using any color inversion techniques known to those skilled in the art such as in the RGB color space subtracting 1.0 from the original value and in the HSL color space subtracting the L value from 1.0. In some examples, in response to inverting the one or more colors of the content, the one or more inverted colors of the content may be converted from a first color space to a second color space. In one example, the first color space is red, green, and blue (RGB) and the second color space is hue, saturation, lightness (HSL). In another example, the first color space is red, green, and blue (RGB) and the second color space is hue, saturation, value (HSV). In yet another example, the first color space is at least one of RGB, HSL, and HSV and the second color space is at least one of RGB, HSL, and HSV.

When the one or more colors of the content are inverted, flow proceeds to operation 306 where the one or more colors of the content are shifted along a color wheel. In one example, the one or more colors of the content are shifted 180 degrees along a color wheel. In one example, the color wheel is based on the HSL color space. In another example, the color wheel is based on the HSV color space. In yet another example, the color wheel is based on the RGB color space. In some examples, in response to shifting the one or more colors of the content along a color wheel, the one or more colors of the content may be converted from the second color space back to the first color space. For example, when the first color space is RGB and the second color space is HSL, the one or more colors of the content may be converted from HSL back to RGB.

When the one or more colors of the content are shifted along a color wheel, flow proceeds to operation 308, where a linear function is applied to the one or more colors of the content. In one example, applying the linear function to the one or more colors of the content may facilitate controlling, adjusting and/or customizing a color intensity of the one or more colors of the content. The linear function may include any linear function suitable for controlling, adjusting, and/or customizing the color intensity of the one or more colors of content such as any standard linear function having one independent variable and one dependent variable. In another example, the color intensity of the one or more colors of content may be adjusted and/or customized by changing (e.g., increasing/decreasing) the L value by a fixed amount (e.g., in the HSL color space). In one example, in response to applying a linear function to the one or more colors of the content, the one or more colors of the content may be converted from the second color space back to the first color space. In one example, applying a linear function to the one or more colors of the content to control a color intensity of the one or more colors of the content may include adjusting the color intensity of the one or more colors of the content from a first color intensity to a second color intensity. In one example, the first color intensity may be more intense than the second color intensity. In another example, the first color intensity may be less intense than the second color intensity.

When a linear function is applied to the one or more colors of the content, flow proceeds to operation 310 where the content is displayed within the application in a user interface. In one example, the content is displayed within the application in a user interface by presenting content initially comprising white color as content comprising black color and presenting content initially comprising a first color as content comprising the first color. For example, content that is white before the three step color transformation is applied may be presented and/or displayed as black after the three step color transformation is applied. In another example, content that is a first color (e.g., red) before the three step color transformation is applied may be presented and/or displayed as red after the three step color transformation is applied. In one example, the first color is at least one of red, green, blue, yellow, purple, gray, and orange. In another case, the content is displayed within the application in a user interface by presenting content initially comprising white color as content comprising black color and presenting content initially comprising a color having a first color intensity as content comprising the color having a second color intensity. For example, content that is white before the three step color transformation is applied may be presented and/or displayed as black after the three step color transformation is applied. In another example, content comprising a color having a first color intensity (e.g., red) before the three step color transformation is applied may be presented and/or displayed as the color having a second color intensity (e.g., pink) after the three step color transformation is applied.

FIG. 4 illustrates computing system 401 that is representative of any system or collection of systems in which the various applications, services, scenarios, and processes disclosed herein may be implemented. Examples of computing system 401 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 401 may be implemented as a single apparatus, system, or device or may be implemented in a distributed manner as multiple apparatuses, systems, or devices. Computing system 401 includes, but is not limited to, processing system 402, storage system 403, software 405, communication interface system 407, and user interface system 409. Processing system 402 is operatively coupled with storage system 403, communication interface system 407, and user interface system 409.

Processing system 402 loads and executes software 405 from storage system 403. Software 405 includes application 406, which is representative of the applications discussed with respect to the preceding FIGS. 1-3, including word processing applications described herein. When executed by processing system 402 to enhance image correction, software 405 directs processing system 402 to operate as described herein for at least the various processes, operational scenarios, and sequences discussed in the foregoing implementations. Computing system 401 may optionally include additional devices, features, or functionality not discussed for purposes of brevity.

Referring still to FIG. 4, processing system 402 may comprise a micro-processor and other circuitry that retrieves and executes software 405 from storage system 403. Processing system 402 may be implemented within a single processing device, but may also be distributed across multiple processing devices or sub-systems that cooperate in executing program instructions. Examples of processing system 402 include general purpose central processing units, application specific processors, and logic devices, as well as any other type of processing device, combinations, or variations thereof.

Storage system 403 may comprise any computer readable storage media readable by processing system 402 and capable of storing software 405. Storage system 403 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 403 may also include computer readable communication media over which at least some of software 405 may be communicated internally or externally. Storage system 403 may be implemented as a single storage device, but may also be implemented across multiple storage devices or sub-systems co-located or distributed relative to each other. Storage system 403 may comprise additional elements, such as a controller, capable of communicating with processing system 402 or possibly other systems.

Software 405 may be implemented in program instructions and among other functions may, when executed by processing system 402, direct processing system 402 to operate as described with respect to the various operational scenarios, sequences, and processes illustrated herein. For example, software 405 may include program instructions for implementing enhanced image correction technology.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 405 may include additional processes, programs, or components, such as operating system software, virtual machine software, or other application software, in addition to or that include application 406. Software 405 may also comprise firmware or some other form of machine-readable processing instructions executable by processing system 402.

In general, software 405 may, when loaded into processing system 402 and executed, transform a suitable apparatus, system, or device (of which computing system 401 is representative) overall from a general-purpose computing system into a special-purpose computing system customized to facilitate enhanced image correction to compensate for visual impairments. Indeed, encoding software 405 on storage system 403 may transform the physical structure of storage system 403. The specific transformation of the physical structure may depend on various factors in different implementations of this description. Examples of such factors may include, but are not limited to, the technology used to implement the storage media of storage system 403 and whether the computer-storage media are characterized as primary or secondary storage, as well as other factors.

For example, if the computer readable storage media are implemented as semiconductor-based memory, software 405 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 407 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 409 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 409. In some cases, the input and output devices may be combined in a single device, such as a display capable of displaying images and receiving touch gestures. The aforementioned user input and output devices are well known in the art and need not be discussed at length here.

User interface system 409 may also include associated user interface software executable by processing system 402 in support of the various user input and output devices discussed above. Separately or in conjunction with each other and other hardware and software elements, the user interface software and user interface devices may support a graphical user interface, a natural user interface, or any other type of user interface.

Communication between computing system 401 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents systems comprising: one or more computer readable storage media; and program instructions stored on the one or more computer readable storage media that, when executed by at least one processor, cause the at least one processor to at least: identify a special accessibility mode associated with an application comprising content; invert one or more colors of the content to decrease a luminance of the content; shift the one or more colors of the content along a color wheel; apply a linear function to the one or more colors of the content to control a color intensity of the one or more colors of the content; and display the content within the application in a user interface. In further examples, in response to the program instructions causing the at least one processor to invert one or more colors of the content to decrease a luminance of the content, the program instructions, when executed by the at least one processor, further cause the at least one processor to convert the one or more inverted colors of the content from a first color space to a second color space. In further examples, in response to the program instructions causing the at least one processor to shift the one or more colors of the content along a color wheel, the program instructions, when executed by the at least one processor, further cause the at least one processor to convert the one or more colors of the content from the second color space back to the first color space. In further examples, the content is external third party content. In further examples, the content is first party content. In further examples, the content comprises user interface elements. In further examples, the first color space is red, green, and blue (RGB) and the second color space is hue, saturation, lightness (HSL). In further examples, the first color space is red, green, and blue (RGB) and the second color space is hue, saturation, value (HSV). In further examples, the first color space is at least one of RGB, HSL, and HSV and the second color space is at least one of RGB, HSL, and HSV.

Further aspects disclosed herein provide an exemplary computer-implemented method for providing image correction to compensate for visual impairments, the method comprising: identifying a special accessibility mode associated with an application comprising content; inverting one or more colors of the content to decrease a luminance of the content; shifting the one or more colors of the content along a color wheel; applying a linear function to the one or more colors of the content to control a color intensity of the one or more colors of the content; and displaying the content within the application in a user interface. In further examples, in response to inverting the one or more colors of the content to decrease a luminance of the content, further comprising converting the one or more inverted colors of the content from a first color space to a second color space. In further examples, in response to applying a linear function to the one or more colors of the content to control a color intensity of the colors of the content, further comprising converting the one or more colors of the content from the second color space back to the first color space. In further examples, the content is external third party content. In further examples, the content is first party content. In further examples, displaying the content within the application in the user interface comprises presenting content initially comprising white color as content comprising black color and presenting content initially comprising a first color as content comprising the first color. In further examples, the first color is at least one of red, green, blue, yellow, purple, gray, and orange. In further examples, displaying the content within the application in the user interface comprises presenting content initially comprising white color as content comprising black color and presenting content initially comprising a color having a first color intensity as content comprising the color having a second color intensity. In further examples, applying a linear function to the one or more colors of the content to control a color intensity of the one or more colors of the content comprises adjusting the color intensity of the one or more colors of the content from a first color intensity to a second color intensity. In further examples, the first color intensity is more intense than the second color intensity.

Additional aspects disclosed herein provide exemplary systems comprising one or more computer readable storage media; and program instructions stored on the one or more computer readable storage media that, when executed by at least one processor, cause the at least one processor to at least: display content having at least a first color and a second color having a first color intensity within an application in a user interface, wherein the first color is white; and in response to receiving a selection of a special accessibility mode associated with the application: invert the white color to a black color; invert the second color having the first color intensity to a third color; shift the black color of the content and the third color of the content along a color wheel; apply a linear function to the black color of the content and the third color of the content; and in response to applying the linear function to the black color of the content and the third color of the content, display the content within the application in a user interface, wherein the white color of the content is displayed as the black color and the second color having the first color intensity of the content is displayed as the second color having a second color intensity.

Techniques for providing image correction to compensate for visual impairments are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of image correction systems that execute in conjunction with an application program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
one or more computer readable storage media; and
program instructions stored on the one or more computer readable storage media that, when executed by at least one processor, cause the at least one processor to at least:
identify a special accessibility mode associated with an application comprising content;
invert one or more colors of the content to decrease a luminance of the content;
shift the one or more colors of the content along a color wheel;
apply a linear function to the one or more colors of the content to control a color intensity of the one or more colors of the content; and
display the content within the application in a user interface.

2. The system of claim 1, wherein in response to the program instructions causing the at least one processor to invert one or more colors of the content to decrease a luminance of the content, the program instructions, when executed by the at least one processor, further cause the at least one processor to convert the one or more inverted colors of the content from a first color space to a second color space.

3. The system of claim 2, wherein in response to the program instructions causing the at least one processor to shift the one or more colors of the content along a color wheel, the program instructions, when executed by the at least one processor, further cause the at least one processor to convert the one or more colors of the content from the second color space back to the first color space.

4. The system of claim 1, wherein the content is external third party content.

5. The system of claim 1, wherein the content is first party content.

6. The system of claim 1, wherein the content comprises user interface elements.

7. The system of claim 3, wherein the first color space is red, green, and blue (RGB) and the second color space is hue, saturation, lightness (HSL).

8. The system of claim 3, wherein the first color space is red, green, and blue (RGB) and the second color space is hue, saturation, value (HSV).

9. The system of claim 3, wherein the first color space is at least one of RGB, HSL, and HSV and the second color space is at least one of RGB, HSL, and HSV.

10. A computer-implemented method for providing image correction to compensate for visual impairments, the method comprising:
identifying a special accessibility mode associated with an application comprising content;
inverting one or more colors of the content to decrease a luminance of the content;
shifting the one or more colors of the content along a color wheel;
applying a linear function to the one or more colors of the content to control a color intensity of the one or more colors of the content; and
displaying the content within the application in a user interface.

11. The computer-implemented method of claim 10, wherein in response to inverting the one or more colors of the content to decrease a luminance of the content, further comprising converting the one or more inverted colors of the content from a first color space to a second color space.

12. The computer-implemented method of claim 11, wherein in response to applying a linear function to the one or more colors of the content to control a color intensity of the colors of the content, further comprising converting the one or more colors of the content from the second color space back to the first color space.

13. The computer-implemented method of claim 10, wherein the content is external third party content.

14. The computer-implemented method of claim 10, wherein the content is first party content.

15. The computer-implemented method of claim 10, wherein displaying the content within the application in the user interface comprises presenting content initially comprising white color as content comprising black color and presenting content initially comprising a first color as content comprising the first color.

16. The computer-implemented method of claim 15, wherein the first color is at least one of red, green, blue, yellow, purple, gray, and orange.

17. The computer-implemented method of claim 10, wherein displaying the content within the application in the user interface comprises presenting content initially comprising white color as content comprising black color and presenting content initially comprising a color having a first color intensity as content comprising the color having a second color intensity.

18. The computer-implemented method of claim 10, wherein applying a linear function to the one or more colors of the content to control a color intensity of the one or more colors of the content comprises adjusting the color intensity of the one or more colors of the content from a first color intensity to a second color intensity.

19. The computer-implemented method of claim 18, wherein the first color intensity is more intense than the second color intensity.

20. A system comprising:
one or more computer readable storage media; and
program instructions stored on the one or more computer readable storage media that, when executed by at least one processor, cause the at least one processor to at least:
display content having at least a first color and a second color having a first color intensity within an application in a user interface, wherein the first color is white; and
in response to receiving a selection of a special accessibility mode associated with the application:
invert the white color to a black color;
invert the second color having the first color intensity to a third color;
shift the black color of the content and the third color of the content along a color wheel;
apply a linear function to the black color of the content and the third color of the content; and
in response to applying the linear function to the black color of the content and the third color of the content, display the content within the application in a user interface, wherein the white color of the content is displayed as the black color and the second color having the first color intensity of the content is displayed as the second color having a second color intensity.
